(19) United States
(12) Patent Application Publication
(10) Pub. No.: US 2024/0027854 A1
(43) Pub. Date: Jan. 25, 2024

(54) DISPLAY PANEL AND DISPLAY DEVICE

(71) Applicant: Wuhan China Star Optoelectronics Technology Co., Ltd., Wuhan, Hubei (CN)

(72) Inventors: Gengxiu DIAO, Wuhan, Hubei (CN); Liming WAN, Wuhan, Hubei (CN); Peng TU, Wuhan, Hubei (CN)

(73) Assignee: Wuhan China Star Optoelectronics Technology Co., Ltd., Wuhan, Hubei (CN)

(21) Appl. No.: 17/438,984

(22) PCT Filed: Jul. 23, 2021
(86) PCT No.: PCT/CN2021/108292

§ 371 Date: Sep. 14, 2021

(30) Foreign Application Priority Data
Jun. 28, 2021 (CN) 202110717241.8

(51) Int. Cl. G02F 1/1362

(52) U.S. Cl. CPC G02F 1/136286

(57) ABSTRACT

A display panel and a display device are provided. The display panel includes a plurality of independent display areas. Pixels in each of the display areas are respectively driven to display by at least one source drive circuit, and the source drive circuits that drive each of the display areas are electrically insulated. The present disclosure realizes that the display panel has the characteristics of high resolution and large size.

### CROSS REFERENCE

This application claims the priority of a China patent application filed with the China National Intellectual Property Administration on Jun. 28, 2021, with an application number of 202110717241.8 and entitled “Display Panel and Display Device”, the entire content of which is incorporated into this application by reference.

### FIELD OF INVENTION

The present disclosure relates to the technical field of display, which particularly relates to a display panel and a display device.

### BACKGROUND OF INVENTION

With the development of the Internet, 5G technology, and artificial intelligence, automobiles are gradually transforming to intelligent and digital, and autonomous driving technology has also entered a stage of rapid development. Once the driverless technology is implemented, the car is likely to become a third space, and in this third space, no matter passengers or drivers have more things to do. Owning a large screen and human-computer interaction system is essential for this kind of driverless car. To enhance the user experience of the driver or passenger, high resolution (PPI) and touch integration is a necessary requirement for the large screen. At present, all source driver chips on the market have an upper resolution limit that can supported. Taking the touch and display driver integration (TDDI) chip as an example, the existing chips on the market can only support up to 4K resolution, which cannot meet the market's requirements for high resolution/high PPI. This problem is particularly serious for large-size displays.

Technical Problems: The technical problems of being unable to meet the requirements of large-size and high-resolution display exist in the source driver chip of the conventional display device.

### SUMMARY OF INVENTION

Technical Solutions: The present disclosure provides a display panel and a display device, which are used to overcome the technical problem that the conventional source driver chip cannot meet the requirements of large-size and high-resolution display.

The present disclosure provides a display panel comprising a display area including at least a first display area and a second display area adjacent to the first display area;

wherein pixels located in the first display area are driven to display by at least one first source drive circuit and pixels located in the second display area are driven to display by at least one second source drive circuit;

wherein the first source drive circuit is electrically insulated from the second source drive circuit.

In the display panel of the present disclosure, the first display area includes first scan lines electrically connected to the pixels located in the first display area, the second display area includes second scan lines electrically connected to the pixels located in the second display area, and the first scan lines are electrically insulated from the second scan lines.

In the display panel of the present disclosure, the first display area includes first data lines electrically connected to the pixels located in the first display area, the second display area includes second data lines electrically connected to the pixels located in the second display area, and the first data lines are electrically insulated from the second data lines.

In the display panel of the present disclosure, the first scan lines and the second scan lines extend along a first direction, and the first display area and the second display area are arranged side by side along the first direction.

In the display panel of the present disclosure, a length of the first display area along the first direction is equal to a length of the second display area along the first direction.

In the display panel of the present disclosure, the first scan lines are electrically connected to a first gate drive circuit, the second scan lines are electrically connected to a second gate drive circuit, and the first gate drive circuit and the second gate drive circuit are arranged side by side on opposite sides of the display area along the first direction.

In the display panel of the present disclosure, the first data lines and the second data lines extend along a second direction, and the first display area and the second display area are arranged side by side along the second direction.

In the display panel of the present disclosure, a length of the first display area along the second direction is equal to a length of the second display area along the second direction.

In the display panel of the present disclosure, the first scan lines are electrically connected to a gate drive circuit, and the first gate drive circuit and the first display area are arranged side by side along the first direction.

In the display panel of the present disclosure, the first gate drive circuit includes a first gate sub-drive circuit and a second gate sub-drive circuit, and the first gate sub-drive circuit and the second gate sub-drive circuit are arranged side by side on opposite sides of the first display area along the first direction.

In the display panel of the present disclosure, one of the two adjacent first scan lines is electrically connected to the first gate sub-drive circuit, and another first scan line is electrically connected to the second gate sub-drive circuit.

In the display panel of the present disclosure, the second scan lines electrically connected to the second gate drive circuit, and the second gate drive circuit and the second display area are arranged side by side along the first direction.

In the display panel of the present disclosure, the second gate drive circuit includes a third sub-drive circuit and a fourth gate sub-drive circuit, the third gate sub-drive circuit and the fourth gate sub-drive circuit are arranged side by side on opposite sides of the second display area along the first direction.

In the display panel of the present disclosure, one of the two adjacent second scan lines is electrically connected to the third gate sub-drive circuit, and another second scan line is electrically connected to the fourth gate sub-drive circuit.

In the display panel of the present disclosure, the pixels located in the first display area include a plurality of first pixel electrodes, and the first source drive circuit is electrically connected to the first pixel electrodes through the first data lines; and

the pixels located in the second display area include a plurality of second pixel electrodes, and the second source drive circuit is electrically connected to the second pixel electrodes through the second data lines.

In the display panel of the present disclosure, the first display area includes a first common electrode, the second display area includes a second common electrode, and the first common electrode is electrically insulated from the second common electrode.

In the display panel of the present disclosure, the display panel further comprises a linkage control unit electrically connected to the first source drive and the second source drive circuit.

The present disclosure provides a display panel comprising a display area including a first display area and a second display area adjacent to the first display area;

wherein pixels located in the first display area are driven to display by a first source drive circuit and pixels located in the second display area are driven to display by a second source drive circuit;

wherein first scan lines are arranged in the first display area and

electrically connected to the pixels located in the first display area, second scan lines are arranged in the second display area and electrically connected to the pixels located in the second display area, the first scan lines and the second scan lines extend along a first direction, and the first display area and the second display area are arranged side by side along the first direction;

wherein the first source drive circuit is electrically insulated from the second source drive circuit, and the first scan lines are electrically insulated from the second scan lines.

The present disclosure further provides a display device comprising a display panel, wherein the display panel comprises a display area including at least a first display area and a second display area adjacent to the first display area;

wherein pixels located in the first display area are driven to display by at least one first source drive circuit and pixels located in the second display area are driven to display by at least one second source drive circuit;

wherein the first source drive circuit is electrically insulated from the second source drive circuit.

In the display device of the present disclosure, first scan lines are arranged in the first display area and electrically connected to the pixels located in the first display area, second scan lines are arranged in the second display area and electrically connected to the pixels located in the second display area, the first scan lines and the second scan lines extend along a first direction, and the first display area and the second display area are arranged side by side along the first direction. The first scan lines are electrically insulated from the second scan lines.

Beneficial Effects: The present disclosure provides a display panel and a display device, wherein the display panel comprises a display area including at least a first display area and a second display area adjacent to the first display area, pixels are located in the first display area are driven to display by at least one first source drive circuit and pixels are located in the second display area are driven to display by at least one second source drive circuit, and the first source drive circuit is electrically insulated from the second source drive circuit. In the present disclosure, the display area of the display panel is divided into multiple independent display areas, and each of the display areas is driven by a different group of source driving circuits for displaying, so that the resolution of the display panel can break through the capability limitation of the used source driver chip, thereby prompting the display panel to realize the characteristics of high resolution and large size.

### DESCRIPTION OF DRAWINGS

To describe the technical solutions more clearly in the embodiments of the present disclosure, the following will briefly introduce the drawings that need to be used in the description of the embodiments. Obviously, the drawings in the following description are only some embodiments of the present disclosure, and for those skilled in the art, other drawings can be obtained based on these drawings without creative work.

FIG. 1 is a schematic diagram of a first pixel structure of a display panel according to an embodiment of the present disclosure.

FIG. 2 is a schematic diagram of a second pixel structure of a display panel according to an embodiment of the present disclosure.

FIG. 3 is a schematic diagram of a third pixel structure of a display panel according to an embodiment of the present disclosure.

FIG. 4 is a schematic diagram of a fourth pixel structure of a display panel according to an embodiment of the present disclosure.

FIG. 5 is a schematic diagram of a fifth pixel structure of a display panel according to an embodiment of the present disclosure.

FIG. 6 is a schematic diagram of a sixth pixel structure of a display panel according to an embodiment of the present disclosure.

FIG. 7 is a schematic diagram of a seventh pixel structure of a display panel according to an embodiment of the present disclosure.

FIG. 8 is a schematic diagram of a partial cross-sectional structure of a display panel according to an embodiment of the present disclosure.

### DETAILED DESCRIPTION OF PREFERRED EMBODIMENTS

The description of the following embodiments refers to the attached drawings to illustrate specific embodiments that the present disclosure can be implemented. The direction terms mentioned in the present invention, such as up, down, front, back, left, right, inner, outer, side, etc., are only directions for referring to the attached drawings. Therefore, the directional terms used are used to illustrate and understand the present disclosure, rather than to limit the present disclosure. In the figure, units with similar structures are indicated by the same reference numerals.

The present disclosure provides a display panel, wherein the display panel comprises a display area including at least a first display area and a second display area adjacent to the first display area. The first display area includes first pixels, and the second display area includes second pixels. The first pixels are driven to display by a first source drive circuit, and the second pixels are driven to display by a second source drive circuit. The first source drive circuit is electrically insulated from the second source drive circuit. In the embodiment of the present disclosure, the display area of the display panel is divided into the first display area and the second display area that are independent of each other, and the first display area and the second display area are driven by two independent source drive circuits for display. The resolution of the display panel can break through the limitation of the used source driver chip, thereby enabling the display panel to achieve the characteristics of high resolution and large size.

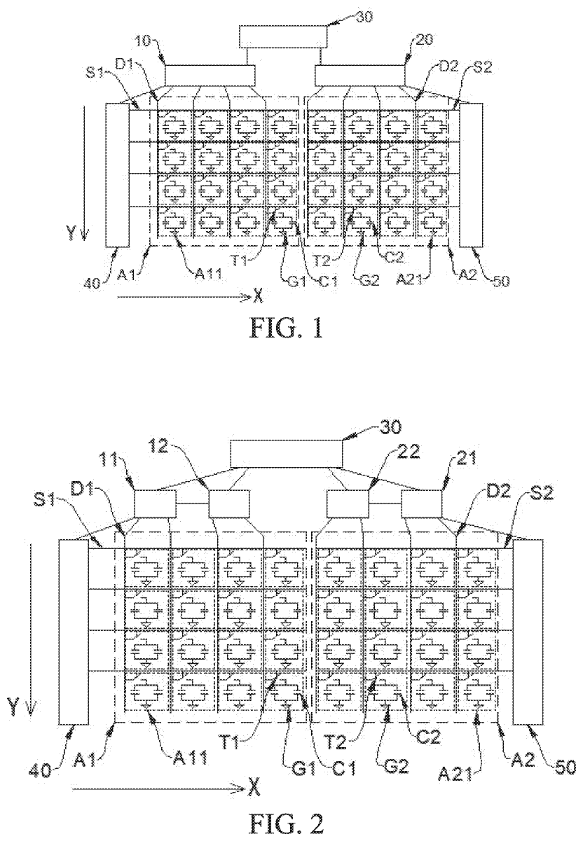

Refer to FIG. 1, FIG. 1 is a schematic diagram of a first pixel structure of a display panel according to an embodiment of the present disclosure. The display panel includes a display area, and the display area includes a first display area A1 and a second display area A2 adjacent to the first display area A1. The first display area A1 and the second display area A2 are seamlessly connected to form a complete display area. When the display panel is manufactured, the display modules in the first display area A1 and the display modules in the second display area A2 are manufactured by the same or similar process on a same substrate. At the junction of the first display area A1 and the second display area A2, a distance between the pixel in the first display area A1 and the pixel in the second display area A2 is equal to a distance between adjacent pixels in the first display area A1, or the distance between the pixel in the first display area A1 and the pixel in the second display area A2 is equal to a distance between adjacent pixels in the second display area A2.

The display panel further include a non-display area disposed on the periphery of the display area, and the non-display area is provided with a drive control circuit and other constituent elements that play a mediating and control effect on the display function of the display area.

The first display area A1 includes a plurality of first pixels A11, and the second display area A2 includes a plurality of second pixels A21. The first pixels A11 are driven by a first source drive circuit 10 for displaying, and the second pixels A21 are driven by the second source drive circuit 20 for displaying. The first pixel A11 is a basic display unit in the first display area A1, and each of the first pixels A11 includes a pixel circuit, a pixel electrode, a common electrode, etc., for realizing its display function. The second pixel A21 is a basic display unit in the second display area A2, and each of the second pixels A21 includes a pixel circuit, a pixel electrode, a common electrode, etc., which realize its display function.

The first source drive circuit 10 is used to provide source drive signals for the first pixel A11, such as a data signal; the second source drive circuit 20 is used to provide source drive signals for the second pixel A21, such as data signal.

The first source drive circuit 10 is electrically insulated from the second source drive circuit 20. That is, there is no direct electrical connection relationship between the first source drive circuit 10 and the second source drive circuit 20. For example, there is no cascade relationship between the first source drive circuit 10 and the second source drive circuit 20 that is directly connected by a cascade wiring. The cascade wiring refers to a wiring or control circuit that is directly erected between two source drive circuits to realize the sequential operation of the two source drive circuits.

In the embodiment, the display area of the display panel is divided into the first display area and the second display area that are independent of each other, and the first display area and the second display area are driven by two independent source drive circuits for display. Compared with the current display panel design, the number of source drive circuits in the display panel may be doubled, and the number of pixels driven by the source drive circuit may be doubled. Under the premise of increasing the size of the display panel, the pixel density of the display panel maintains the highest level of the current technology, and the resolution of the display panel maintains the highest level of the current technology, meeting the current market demand for large-size and high-resolution display panels.

Further, the first display area A1 includes a first scan line S1 connected to the first pixel A11, and the second display area A2 includes a second scan line S2 connected to the second pixel A21. Specifically, one end of the first scan line S1 is electrically connected to the first gate drive circuit 40, and the other end of the first scan line S1 is electrically connected to the first pixel A11. The gate drive signal output by the first gate drive circuit 40 is transmitted to the first pixel A11 through the first scan line S1. One end of the second scan line S2 is electrically connected to the second gate drive circuit 50, and the other end of the second scan line S2 is electrically connected to the second pixel A21. The gate drive signal output by the second gate drive circuit 50 is transmitted to the second pixel A21 through the second scan line S2.

The first scan line S1 is electrically insulated from the second scan line S2. That is, there is no electrical connection relationship between the first scan line S1 and the second scan line S2. The gate drive signal required by the first pixel A11 to realize its display function is completely provided by the first gate drive circuit 40 through the first scan line S1. The gate drive signal required by the second pixel A21 to realize its display function is completely provided by the second gate drive circuit 50 through the second scan line S2. In this way, the first pixel A11 and the second pixel A21 are independent of each other.

Further, the first display area A1 further includes a first data line D1 connected to the first pixel A11. The second display area A2 further includes a second data line D2 connected to the second pixel A21. Specifically, one end of the first data line D1 is electrically connected to the first source drive circuit 10. The other end of the first data line D1 is electrically connected to the first pixel A11. The source drive signal output by the first source drive circuit 10 is transmitted to the first pixel A11 through the first data line D1. One end of the second data line D2 is electrically connected to the second source drive circuit 20. The other end of the second data line D2 is electrically connected to the second pixel A21. The source drive signal output by the second source drive circuit 20 is transmitted to the second pixel A21 through the second data line D2.

The first data line D1 is electrically insulated from the second data line D2. That is, there is no direct electrical connection relationship between the first data line D1 and the second data line D2. The source drive signal required by the first pixel A11 to realize its display function is completely provided by the first source drive circuit 10 through the first data line D1. The source drive signal required by the second pixel A21 to realize its display function is completely provided by the second source drive circuit 20 through the second data line D2. In this way, the first pixel A11 and the second pixel A21 are independent of each other.

Further, the first scan line S1 and the second scan line S2 extend along the first direction X. The first data line D1 and the second data line D2 extend along the second side Y. Optionally, the first direction X and the second direction Y may be two directions perpendicular to each other.

The first display area A1 and the second display area A2 are arranged side by side along the first direction X, so that the length of the display panel along the first direction X is doubled.

Optionally, the length of the first display area A1 along the first direction X is equal to the length of the second display area A2 along the first direction X. In the case that the first display area A1 and the second display area A2 reach the highest resolution of the current technology, the embodiment is beneficial to realize that the length of the display panel along the first direction X reaches the maximum, to realize the large-size and high-resolution display of the display panel.

Further, the first gate drive circuit 40 and the second gate drive circuit 50 are arranged side by side along the first direction X and located on opposite sides of the display areas of the first display area A1 and the second display area A2. The first gate drive circuit 40 is disposed close to the first display area A1, and the second gate drive circuit 50 is disposed close to the second display area A2.

Further, the first display area A1 includes a first common electrode G1, and the second display area A2 includes a second common electrode G2. The first common electrode G1 and the second common electrode G2 are electrically insulated. The first common electrode G1 is an electrode that provides a constant common voltage in the first display area A1. The second common electrode G2 is an electrode that provides a constant common voltage in the second display area A2. The first common electrode G1 and the second common electrode G2 are independent of each other and have no electrical connection relationship.

In the first display area A1, each of the first pixels A11 includes a first pixel electrode, and the first pixel electrode is connected to the first data line D1 through a first transistor T1 and is further connected to the first source drive circuit 10. The first pixel A11 further includes a first capacitor C1, one end of the first capacitor C1 is connected to the first transistor T1, and the other end of the first capacitor C1 is connected to the first common electrode G1.

In the second display area A2, each of the second pixels A21 includes a second pixel electrode. The second pixel electrode is connected to the second data line D2 through a second transistor T2 and is further connected to the second source drive circuit 20. The second pixel A21 further includes a second capacitor C2. One end of the second capacitor C2 is connected to the second transistor T2, and the other end of the second capacitor C2 is connected to the second common electrode G2.

Further, the display panel further includes a linkage control unit 30. The linkage control unit 30 is electrically connected to the first source drive circuit 10 and the second source drive circuit 20. The linkage control unit 30 is used for coordinating the working timing of the first source drive circuit 10 to be consistent with the working timing of the second source drive circuit 20. In this way, the consistency of the display images of the first display area A1 and the second display area A2 is ensured.

In the embodiment, the display area of the display panel is divided into the first display area and the second display area that are independent of each other, and the first display area and the second display area are driven by two independent source drive circuits for display. The number of source drive circuits and the number of pixels driven by the source drive circuit in the display panel are increased, so that the display panel has high resolution while increasing the size of the display panel.

In an embodiment, refer to FIG. 2, FIG. 2 is a schematic diagram of a second pixel structure of a display panel according to an embodiment of the present disclosure. The display panel shown in FIG. 2 has the same or similar structural features as the display panel shown in FIG. 1. The structural features of the display panel shown in FIG. 2 will be described below. For the parts that are not described in detail, please refer to the description of the structural features of the display panel shown in FIG. 1 in the foregoing embodiment.

The display panel includes a display area, and the display area includes a first display area A1 and a second display area A2 adjacent to the first display area A1. The first display area A1 and the second display area A2 are seamlessly connected to form a complete display area.

The first display area A1 includes a plurality of first pixels A11, and the second display area A2 includes a plurality of second pixels A21. The first pixels A11 are driven by the first source drive circuit for displaying, and the second pixels A21 are driven by the second source drive circuit for displaying.

The first source drive circuit includes a first source sub-drive circuit 11 and a second source sub-drive circuit 12. The first source sub-drive circuit 11 and the second source sub-drive circuit 12 are electrically connected through cascade wiring. It works to realize the first source sub-drive circuit 11 and the second source sub-drive circuit 12. The first source sub-drive circuit 11 and the second source sub-drive circuit 12 may respectively drive the same number of the first pixels A11.

The second source drive circuit includes a third source sub-drive circuit 21 and a fourth source sub-drive circuit 22. The third source sub-drive circuit 21 and the fourth source sub-drive circuit 22 are electrically connected through cascade wiring. It works to realize the third source sub-drive circuit 21 and the fourth source sub-drive circuit 22. The third source sub-drive circuit 21 and the fourth source sub-drive circuit 22 may respectively drive the same number of the second pixels A21.

The first source sub-drive circuit 11 and the second source sub-drive circuit 12 are used to provide source drive signals, such as data signals, for the first pixel A11. The third source sub-drive circuit 21 and the fourth source sub-drive circuit 22 are used to provide source drive signals, such as data signals, for the second pixel A21.

The first source drive circuit is electrically insulated from the second source drive circuit. That is, there is no direct electrical connection relationship between the first source drive circuit and the second source drive circuit, such as a cascade connection.

Further, the first display area A1 includes a first scan line S1 connected to the first pixel A11. The second display area A2 includes a second scan line S2 connected to the second pixel A21. Specifically, one end of the first scan line S1 is electrically connected to the first gate drive circuit 40. The other end of the first scan line S1 is electrically connected to the first pixel A11. The gate drive signal output by the first gate drive circuit 40 is transmitted to the first pixel A11 through the first scan line S1. One end of the second scan line S2 is electrically connected to the second gate drive circuit 50. The other end of the second scan line S2 is electrically connected to the second pixel A21. The gate drive signal output by the second gate drive circuit 50 is transmitted to the second pixel A21 through the second scan line S2.

The first scan line S1 is electrically insulated from the second scan line S2. That is, there is no electrical connection relationship between the first scan line S1 and the second scan line S2. The gate drive signal required by the first pixel A11 to realize its display function is completely provided by the first gate drive circuit 40 through the first scan line S1. The gate drive signal required by the second pixel A21 to realize its display function is completely provided by the second gate drive circuit 50 through the second scan line S2. In this way, the first pixel A11 and the second pixel A21 are independent of each other.

Further, the first display area A1 further includes a first data line D1 connected to the first pixel A11. The second display area A2 further includes a second data line D2 connected to the second pixel A21. One end of the first data line D1 is electrically connected to the first source drive circuit. A part of the first data line D1 is electrically connected to the first source sub-drive circuit 11. Another part of the first data line D1 is electrically connected to the second source sub-drive circuit 12. The other end of the first data line D1 is electrically connected to the first pixel A11. One end of the second data line D2 is electrically connected to the second source drive circuit. A part of the second data line D2 is electrically connected to the third source sub-drive circuit 21. Another part of the second data line D2 is electrically connected to the fourth source sub-drive circuit 22. The other end of the second data line D2 is electrically connected to the second pixel A21.

The first data line D1 is electrically insulated from the second data line D2. That is, there is no electrical connection relationship between the first data line D1 and the second data line D2. The source drive signal required by the first pixel A11 to realize its display function is completely provided by the first source drive circuit through the first data line D1. The source drive signal required by the second pixel A21 to realize its display function is completely provided by the second source drive circuit through the second data line D2. In this way, the first pixel A11 and the second pixel A21 are independent of each other.

Further, the first scan line S1 and the second scan line S2 extend along a first direction X, and the first data line D1 and the second data line D2 extend along a second direction Y.

The first display area A1 and the second display area A2 are arranged side by side along the first direction X, so that the length of the display panel along the first direction X is doubled.

Optionally, the length of the first display area A1 along the first direction X is equal to the length of the second display area A2 along the first direction X. In the case that the first display area A1 and the second display area A2 reach the highest resolution of the current technology. The embodiment is beneficial to realize that the length of the display panel along the first direction X reaches the maximum value, thereby realizing a large-size and high-resolution display of the display panel.

Further, the first gate drive circuit 40 and the second gate drive circuit 50 are arranged side by side along the first direction X and located on opposite sides of the display areas of the first display area A1 and the second display area A2. The first gate drive circuit 40 is disposed close to the first display area A1, and the second gate drive circuit 50 is disposed close to the second display area A2.

Further, the first display area A1 includes a first common electrode G1, and the second display area A2 includes a second common electrode G2.

In the first display area A1, each of the first pixels A11 includes a first pixel electrode, and the first pixel electrode is connected to the first data line D1 through a first transistor T1 and is further connected to the first source drive circuit 10. The first pixel A11 further includes a first capacitor C1, one end of the first capacitor C1 is connected to the first transistor T1, and the other end of the first capacitor C1 is connected to the first common electrode G1.

In the second display area A2, each of the second pixels A21 includes a second pixel electrode. The second pixel electrode is connected to the second data line D2 through a second transistor T2 and is further connected to the second source drive circuit 20. The second pixel A21 further includes a second capacitor C2. One end of the second capacitor C2 is connected to the second transistor T2, and the other end of the second capacitor C2 is connected to the second common electrode G2.

Further, the display panel further includes a linkage control unit 30.

The linkage control unit 30 is electrically connected to the first source drive circuit and the second source drive circuit. Optionally, the linkage control unit is electrically connected to at least one of the first source sub-drive circuit 11 and the second source sub-drive circuit 12. The linkage control unit 30 is electrically connected to at least one of the third source sub-drive circuit 21 and the fourth source sub-drive circuit 22. The linkage control unit 30 is used for coordinating the working timing of the first source drive circuit to be consistent with the working timing of the second source drive circuit. In this way, the consistency of the display images of the first display area A1 and the second display area A2 is ensured.

In the embodiment, the display area of the display panel is divided into the first display area and the second display area that are independent of each other, and the first display area and the second display area are driven by two independent source drive circuits for display. The number of source drive circuits and the number of pixels driven by the source drive circuit in the display panel are increased, so that the display panel has high resolution while increasing the size of the display panel.

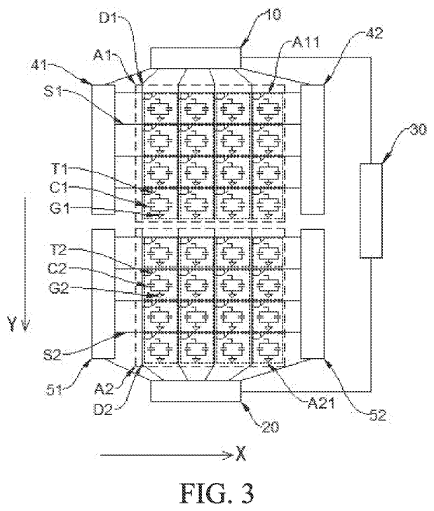

In an embodiment, refer FIG. 3, FIG. 3 is a schematic diagram of a third pixel structure of a display panel according to an embodiment of the present disclosure. The display panel shown in FIG. 3 has the same or similar structural features as the display panel shown in FIG. 1. The structural features of the display panel shown in FIG. 3 will be described below. For the parts that are not described in detail, please refer to the description of the structural features of the display panel shown in FIG. 1 in the foregoing embodiment.

The display panel includes a display area, and the display area includes a first display area A1 and a second display area A2 adjacent to the first display area A1. The first display area A1 and the second display area A2 are seamlessly connected to form a complete display area. When manufacturing the display panel, each display module in the first display area A1 and each display module in the second display area A2 are manufactured on the same substrate through the same or similar process. At the junction of the first display area A1 and the second display area A2, a distance between the pixel in the first display area A1 and the pixel in the second display area A2 is equal to a distance between adjacent pixels in the first display area A1, or the distance between the pixel in the first display area A1 and the pixel in the second display area A2 is equal to a distance between adjacent pixels in the second display area A2.

The first display area A1 includes a plurality of first pixels A11, and the second display area A2 includes a plurality of second pixels A21. The first pixels A11 are driven by a first source drive circuit 10 for displaying, and the second pixels A21 are driven by the second source drive circuit 20 for displaying.

The first source drive circuit 10 is used to provide source drive signals for the first pixel A11, such as a data signal; the second source drive circuit 20 is used to provide source drive signals for the second pixel A21, such as data signal.

The first source drive circuit 10 is electrically insulated from the second source drive circuit 20. That is, there is no direct electrical connection relationship between the first source drive circuit 10 and the second source drive circuit 20, such as cascading relationship, etc.

Further, the first display area A1 includes a first scan line S1 and a first data line D1 connected to the first pixel A11. The second display area A2 includes a second scan line S2 and a second data line D2 connected to the second pixel A21. The first scan line S1 and the second scan line S2 extend along the first direction X, and the first data line D1 and the second data line D2 extend along the second direction Y. Optionally, the first direction X and the second direction Y may be two directions perpendicular to each other.

Specifically, the first scan line S1 is electrically connected between the first gate drive circuit and the first pixel A11. The first gate drive circuit includes a first gate sub-drive circuit 41 and a second gate sub-drive circuit 42. The first gate sub-drive circuit 41 and the second gate sub-drive circuit 42 are arranged side by side on opposite sides of the first display area A1 along the first direction X.

The second scan line S2 is electrically connected between the second gate drive circuit and the second pixel A21. The second gate drive circuit includes a third gate sub-drive circuit 51 and a fourth gate sub-drive circuit 52. The third gate sub-drive circuit 51 and the fourth gate sub-drive circuit 52 are arranged side by side on opposite sides of the second display area A2 along the first direction X.

Optionally, the first display area A1 and the second display area A2 are in a bilateral drive mode as shown in FIG. 3. In this drive mode, the first gate sub-drive circuit 41 and the second gate sub-drive circuit 42 on two sides of each of the first scan lines S1 remain electrically connected. Thus, the gate drive signal is provided for the first pixel A11 from two sides at the same time. The third gate sub-drive circuit 51 and the fourth gate sub-drive circuit 52 on two sides of each second scan line S2 maintain electrical connection. Thus, the gate drive signal is provided to the second pixel A21 from both sides at the same time. The design of this embodiment may improve the uniformity of the gate drive signal distribution in the entire display area.

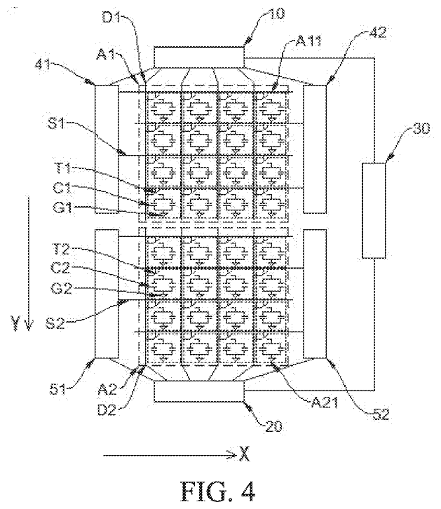

Optionally, the first display area A1 and the second display area A2 may also be in a unilateral drive mode as shown in FIG. 4. FIG. 4 is a schematic diagram of a fourth pixel structure of a display panel according to an embodiment of the present disclosure. In this drive mode, one of every two adjacent first scan lines S1 is electrically connected to the first gate sub-drive circuit 41. The other one is electrically connected to the second gate sub-drive circuit 42. One of every two adjacent second scan lines S2 is electrically connected to the third gate sub-drive circuit 51. The other one is electrically connected to the fourth gate sub-drive circuit 52. The design of this embodiment may simplify the first gate sub-drive circuit 41, the second gate sub-drive circuit 42, the third gate sub-drive circuit 51, and the fourth gate sub-drive circuit 52.

Continuing to refer to FIG. 3, the first scan line S1 is electrically insulated from the second scan line S2. That is, there is no electrical connection relationship between the first scan line S1 and the second scan line S2. The first data line D1 is electrically insulated from the second data line D2. That is, there is no electrical connection relationship between the first data line D1 and the second data line D2. In this embodiment, through the above design, the first pixel A11 and the second pixel A21 are independent of each other.

The first display area A1 and the second display area A2 are arranged side by side along the second direction Y, so that the length of the display panel along the second direction Y is doubled.

Optionally, the length of the first display area A1 along the second direction Y is equal to the length of the second display area A2 along the second direction Y. In the case that the first display area A1 and the second display area A2 reach the highest resolution of the current technology, the embodiment is beneficial to realize that the length of the display panel along the second direction Y reaches the maximum value, thereby realizing a large-size and high-resolution display of the display panel.

Further, the first display area A1 includes a first common electrode G1, and the second display area A2 includes a second common electrode G2. The first common electrode G1 and the second common electrode G2 are electrically insulated. The first common electrode G1 is an electrode that provides a constant common voltage in the first display area A1. The second common electrode G2 is an electrode that provides a constant common voltage in the second display area A2. The first common electrode G1 and the second common electrode G2 are independent of each other and have no electrical connection relationship.

In the first display area A1, each of the first pixels A11 includes a first pixel electrode, and the first pixel electrode is connected to the first data line D1 through a first transistor T1 and is further connected to the first source drive circuit 10. The first pixel A11 further includes a first capacitor C1, one end of the first capacitor C1 is connected to the first transistor T1, and the other end of the first capacitor C1 is connected to the first common electrode G1.

In the second display area A2, each of the second pixels A21 includes a second pixel electrode. The second pixel electrode is connected to the second data line D2 through a second transistor T2 and is further connected to the second source drive circuit 20. The second pixel A21 further includes a second capacitor C2. One end of the second capacitor C2 is connected to the second transistor T2, and the other end of the second capacitor C2 is connected to the second common electrode G2.

Further, the display panel further includes a linkage control unit 30. The linkage control unit 30 is electrically connected to the first source drive circuit 10 and the second source drive circuit 20. The linkage control unit 30 is used for coordinating the working timing of the first source drive circuit 10 to be consistent with the working timing of the second source drive circuit 20. In this way, the consistency of the display images of the first display area A1 and the second display area A2 is ensured.

In the embodiment, the display area of the display panel is divided into the first display area and the second display area that are independent of each other, and the first display area and the second display area are driven by two independent source drive circuits for display. The number of source drive circuits and the number of pixels driven by the source drive circuit in the display panel are increased, so that the display panel has high resolution while increasing the size of the display panel.

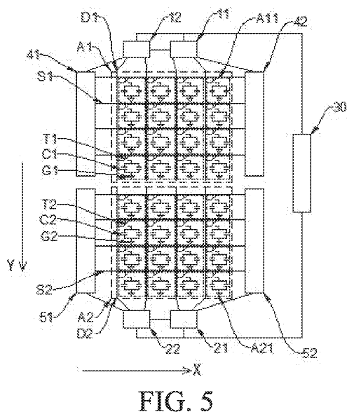

In an embodiment, refer to FIG. 5, FIG. 5 is a schematic diagram of a fifth pixel structure of a display panel according to an embodiment of the present disclosure. The display panel shown in FIG. 5 has the same or similar structural features as the display panel provided in the foregoing embodiment. The structural features of the display panel shown in FIG. 5 will be described below. For the parts that are not described in detail, please refer to the description of the above-mentioned embodiment.

The display panel includes a display area, and the display area includes a first display area A1 and a second display area A2 adjacent to the first display area A1. The first display area A1 and the second display area A2 are seamlessly connected to form a complete display area.

The first display area A1 includes a plurality of first pixels A11, and the second display area A2 includes a plurality of second pixels A21. The first pixels A11 are driven by the first source drive circuit for displaying, and the second pixels A21 are driven by the second source drive circuit for displaying.

The first source drive circuit includes a first source sub-drive circuit 11 and a second source sub-drive circuit 12. The first source sub-drive circuit 11 and the second source sub-drive circuit 12 are electrically connected through cascade wiring. It works to realize the first source sub-drive circuit 11 and the second source sub-drive circuit 12. The first source sub-drive circuit 11 and the second source sub-drive circuit 12 may respectively drive the same number of the first pixels A11.

The second source drive circuit includes a third source sub-drive circuit 21 and a fourth source sub-drive circuit 22. The third source sub-drive circuit 21 and the fourth source sub-drive circuit 22 are electrically connected through cascade wiring. It works to realize the third source sub-drive circuit 21 and the fourth source sub-drive circuit 22. The third source sub-drive circuit 21 and the fourth source sub-drive circuit 22 may respectively drive the same number of the second pixels A21.

The first source sub-drive circuit 11 and the second source sub-drive circuit 12 are used to provide source drive signals, such as data signals, for the first pixel A11. The third source sub-drive circuit 21 and the fourth source sub-drive circuit 22 are used to provide source drive signals, such as data signals, for the second pixel A21.

The first source drive circuit is electrically insulated from the second source drive circuit. That is, there is no direct electrical connection relationship between the first source drive circuit and the second source drive circuit, such as a cascade connection.

Further, the first display area A1 includes a first scan line S1 and a first data line D1 connected to the first pixel A11. The second display area A2 includes a second scan line S2 and a second data line D2 connected to the second pixel A21. The first scan line S1 and the second scan line S2 extend along the first direction X, and the first data line D1 and the second data line D2 extend along the second direction Y. Optionally, the first direction X and the second direction Y may be two directions perpendicular to each other.

Specifically, the first scan line S1 is electrically connected between the first gate drive circuit and the first pixel A11. The first gate drive circuit includes a first gate sub-drive circuit 41 and a second gate sub-drive circuit 42. The first gate sub-drive circuit 41 and the second gate sub-drive circuit 42 are arranged side by side on opposite sides of the first display area A1 along the first direction X.

The second scan line S2 is electrically connected between the second gate drive circuit and the second pixel A21. The second gate drive circuit includes a third gate sub-drive circuit 51 and a fourth gate sub-drive circuit 52. The third gate sub-drive circuit 51 and the fourth gate sub-drive circuit 52 are arranged side by side on opposite sides of the second display area A2 along the first direction X.

Optionally, the first display area A1 and the second display area A2 are in a bilateral drive mode as shown in FIG. 5. In this drive mode, the first gate sub-drive circuit 41 and the second gate sub-drive circuit 42 on two sides of each of the first scan lines S1 remain electrically connected. Thus, the gate drive signal is provided for the first pixel A11 from two sides at the same time. The third gate sub-drive circuit 51 and the fourth gate sub-drive circuit 52 on two sides of each second scan line S2 maintain electrical connection. Thus, the gate drive signal is provided to the second pixel A21 from both sides at the same time. The design of this embodiment may improve the uniformity of the gate drive signal distribution in the entire display area.

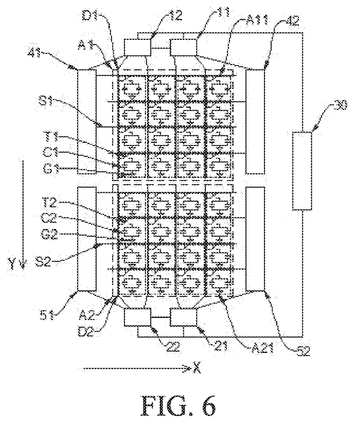

Optionally, the first display area A1 and the second display area A2 may also be in a unilateral drive mode as shown in FIG. 6. FIG. 6 is a schematic diagram of a sixth pixel structure of a display panel according to an embodiment of the present disclosure. In this drive mode, one of every two adjacent first scan lines S1 is electrically connected to the first gate sub-drive circuit 41. The other one is electrically connected to the second gate sub-drive circuit 42. One of every two adjacent second scan lines S2 is electrically connected to the third gate sub-drive circuit 51. The other one is electrically connected to the fourth gate sub-drive circuit 52. The design of this embodiment may simplify the first gate sub-drive circuit 41, the second gate sub-drive circuit 42, the third gate sub-drive circuit 51, and the fourth gate sub-drive circuit 52.

Continuing to refer to FIG. 5, the first scan line S1 is electrically insulated from the second scan line S2. That is, there is no electrical connection relationship between the first scan line S1 and the second scan line S2. The first data line D1 is electrically insulated from the second data line D2. That is, there is no electrical connection relationship between the first data line D1 and the second data line D2. In this embodiment, through the above design, the first pixel A11 and the second pixel A21 are independent of each other.

The first display area A1 and the second display area A2 are arranged side by side along the second direction Y, so that the length of the display panel along the second direction Y is doubled.

Optionally, the length of the first display area A1 along the second direction Y is equal to the length of the second display area A2 along the second direction Y. In the case that the first display area A1 and the second display area A2 reach the highest resolution of the current technology, the embodiment is beneficial to realize that the length of the display panel along the second direction Y reaches the maximum value, thereby realizing a large-size and high-resolution display of the display panel.

Further, the first display area A1 includes a first common electrode G1, and the second display area A2 includes a second common electrode G2. The first common electrode G1 and the second common electrode G2 are electrically insulated.

In the first display area A1, each of the first pixels A11 includes a first pixel electrode, and the first pixel electrode is connected to the first data line D1 through a first transistor T1 and is further connected to the first source drive circuit 10. The first pixel A11 further includes a first capacitor C1, one end of the first capacitor C1 is connected to the first transistor T1, and the other end of the first capacitor C1 is connected to the first common electrode G1.

In the second display area A2, each of the second pixels A21 includes a second pixel electrode. The second pixel electrode is connected to the second data line D2 through a second transistor T2 and is further connected to the second source drive circuit 20. The second pixel A21 further includes a second capacitor C2. One end of the second capacitor C2 is connected to the second transistor T2, and the other end of the second capacitor C2 is connected to the second common electrode G2.

Further, the display panel further includes a linkage control unit 30.

The linkage control unit 30 is electrically connected to the first source drive circuit and the second source drive circuit. Optionally, the linkage control unit is electrically connected to at least one of the first source sub-drive circuit 11 and the second source sub-drive circuit 12. The linkage control unit 30 is electrically connected to at least one of the third source sub-drive circuit 21 and the fourth source sub-drive circuit 22. The linkage control unit 30 is used for coordinating the working timing of the first source drive circuit to be consistent with the working timing of the second source drive circuit. In this way, the consistency of the display images of the first display area A1 and the second display area A2 is ensured.

In the embodiment, the display area of the display panel is divided into the first display area and the second display area that are independent of each other, and the first display area and the second display area are driven by two independent source drive circuits for display. The number of source drive circuits and the number of pixels driven by the source drive circuit in the display panel are increased, so that the display panel has high resolution while increasing the size of the display panel.

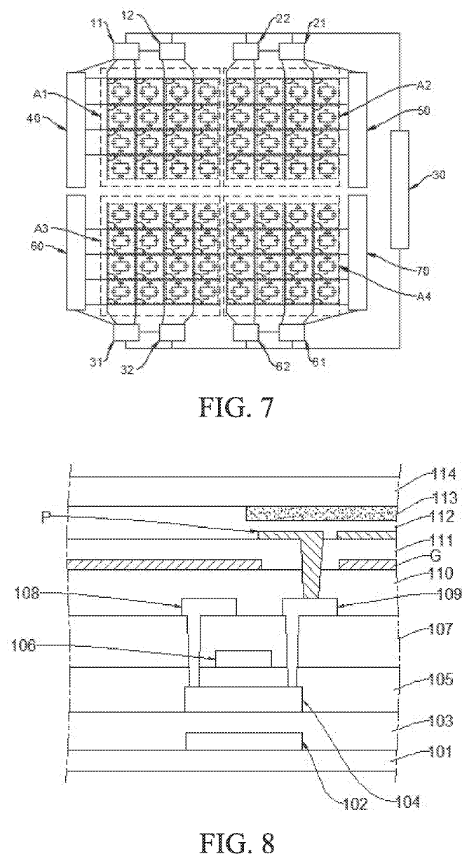

In an embodiment, refer to FIG. 7, FIG. 7 is a schematic diagram of a fifth pixel structure of a display panel according to an embodiment of the present disclosure. The display panel shown in FIG. 7 has the same or similar structural features as the display panel provided in the foregoing embodiment. The structural features of the display panel shown in FIG. 7 will be described below. For the parts that are not described in detail, please refer to the description of the above-mentioned embodiment.

The display panel includes a display area, and the display area includes a first display area A1, a second display area A2, a third display area A3, and a fourth display area A4. The first display area A1, the second display area A2, the third display area A3, and the fourth display area A4 are seamlessly connected to form a complete display area.

A part of the pixels in the first display area A1 provide source driving through the first source sub-driving circuit 11. Another part of the pixels in the first display area A1 provides source driving through the second source sub-driving circuit 12. The pixels in the first display area A1 provide gate driving through the first gate driving circuit 40.

A part of the pixels in the second display area A2 provide source driving through the third source sub-driving circuit 21. The other part of the pixels in the second display area A2 provide source driving through the fourth source sub-driving circuit 22. The pixels in the second display area A2 provide gate driving through the second gate driving circuit 50.

A part of the pixels in the third display area A3 provide source driving through the fifth source sub-driving circuit 31. Another part of the pixels in the third display area A3 provides source driving through the sixth source sub-driving circuit 32. The pixels in the third display area A3 provide gate driving through the third gate driving circuit 60.

A part of the pixels in the fourth display area A4 are source driven by the seventh source sub-driving circuit 61. Another part of the pixels in the fourth display area A4 provides source driving through the eighth source sub-driving circuit 62. The pixels in the fourth display area A4 provide gate driving through the fourth gate driving circuit 70.

The first source sub-driving circuit 11 and the second source sub-driving circuit 12 are electrically connected through cascade wiring. The third source sub-driving circuit 21 and the fourth source sub-driving circuit 22 are electrically connected through cascade wiring. The fifth source sub-driving circuit 31 and the sixth source sub-driving circuit 32 are electrically connected through cascade wiring. The seventh source sub-driving circuit 61 and the eighth source sub-driving circuit 62 are electrically connected through cascade wiring.

There is no cascade relationship between one of the first source sub-driving circuit 11 and the second source sub-driving circuit 12 and one of the third source sub-driving circuit 21 and the fourth source sub-driving circuit 22. There is no cascade relationship between one of the fifth source sub-driving circuit 31 and the sixth source sub-driving circuit 32 and one of the seventh source sub-driving circuit 61 and the eighth source sub-driving circuit 62.

Further, the display panel further includes a linkage control unit 30 electrically connected to the first source sub-driving circuit 11, the second source sub-driving circuit 12, the third source sub-drive circuit 21, the fourth source sub-driving circuit 22, the fifth source sub-driving circuit 31, the sixth source sub-driving circuit 32, the seventh source sub-driving circuit 61, and the eighth source sub-driving circuit 62. The linkage control unit 30 is used to coordinate the working timing of each source sub-drive circuit to be consistent. Therefore, the consistency of the display images of the first display area A1, the second display area A2, the third display area A3, and the fourth display area A4 is ensured.

In an embodiment, refer to FIG. 8, FIG. 8 is a schematic diagram of a partial cross-sectional structure of a display panel according to an embodiment of the present disclosure.

The display panel includes a first base substrate 101, a shielding layer 102 disposed on the first base substrate 101, a buffer layer 103 covering the shielding layer 102, a semiconductor layer 104 disposed on the buffer layer 103, a gate insulating layer 105 covering the semiconductor layer 104, a gate 106 disposed on the gate insulating layer 105, a interlayer insulating layer 107 covering the gate electrode 106, a source electrode 108 and a drain electrode 109 arranged on the interlayer insulating layer 107, a flat layer 110 covering the source electrode 108 and the drain electrode 109, a common electrode G disposed on the flat layer 110, a passivation layer 111 covering the common electrode G, a pixel electrode P disposed on the passivation layer 111, a liquid crystal layer 112 located on the passivation layer 111, a color resist layer 113 located on the liquid crystal layer 112, and a second base substrate 114 located on the color resist layer 113.

The semiconductor layer 104, the gate electrode 106, the source electrode 108, and the drain electrode 109 constitute a thin film transistor. The thin film transistor is equivalent to the first transistor T1 or the second transistor T2 shown in any one of FIGS. 1 to 6.

The common electrode G is equivalent to the first common electrode G1 or the second common electrode G2 shown in any one of FIGS. 1 to 6. The pixel electrode P is equivalent to the first pixel electrode, or the second pixel electrode described in any one of the embodiments in FIGS. 1 to 6.

The embodiment of the present disclosure also provides a display device. The display device includes the display panel provided in the embodiment of the present disclosure. The display device may be a notebook computer, a tablet computer, a mobile phone, a computer monitor, a television, a navigator, and other instruments with a display screen function.

It should be noted that although the application is disclosed as above in specific embodiments, the above-mentioned embodiments are not intended to limit the present disclosure. Those of ordinary skill in the art can make various changes and modifications without departing from the spirit and scope of the present disclosure. Therefore, the protection scope of the present disclosure is subject to the scope defined by the claims.

What is claimed is:

1. A display panel, comprising:
a display area including at least a first display area and a second display area adjacent to the first display area;
wherein pixels located in the first display area are driven to display by at least one first source drive circuit and pixels located in the second display area are driven to display by at least one second source drive circuit;
wherein the first source drive circuit is electrically insulated from the second source drive circuit.

2. The display panel according to claim 1, wherein the first display area includes first scan lines electrically connected to the pixels located in the first display area, the second display area includes second scan lines electrically connected to the pixels located in the second display area, and the first scan lines are electrically insulated from the second scan lines.

3. The display panel according to claim 2, wherein the first display area includes first data lines electrically connected to the pixels located in the first display area, the second display area includes second data lines electrically connected to the pixels located in the second display area, and the first data lines are electrically insulated from the second data lines.

4. The display panel according to claim 3, wherein the first scan lines and the second scan lines extend along a first direction, and the first display area and the second display area are arranged side by side along the first direction.

5. The display panel according to claim 4, wherein a length of the first display area along the first direction is equal to a length of the second display area along the first direction.

6. The display panel according to claim 4, wherein the first scan lines are electrically connected to a first gate drive circuit, the second scan lines are electrically connected to a second gate drive circuit, and the first gate drive circuit and the second gate drive circuit are arranged side by side on opposite sides of the display area along the first direction.

7. The display panel according to claim 3, wherein the first data lines and the second data lines extend along a second direction, and the first display area and the second display area are arranged side by side along the second direction.

8. The display panel according to claim 7, wherein a length of the first display area along the second direction is equal to a length of the second display area along the second direction.

9. The display panel according to claim 7, wherein the first scan lines are electrically connected to a gate drive circuit, and the first gate drive circuit and the first display area are arranged side by side along the first direction.

10. The display panel according to claim 9, wherein the first gate drive circuit includes a first gate sub-drive circuit and a second gate sub-drive circuit, and the first gate sub-drive circuit and the second gate sub-drive circuit are arranged side by side on opposite sides of the first display area along the first direction.

11. The display panel according to claim 9, wherein one of the two adjacent first scan lines is electrically connected to the first gate sub-drive circuit, and another first scan line is electrically connected to the second gate sub-drive circuit.

12. The display panel according to claim 7, wherein the second scan lines electrically connected to the second gate drive circuit, and the second gate drive circuit and the second display area are arranged side by side along the first direction.

13. The display panel according to claim 12, wherein the second gate drive circuit includes a third sub-drive circuit and a fourth gate sub-drive circuit, the third gate sub-drive circuit and the fourth gate sub-drive circuit are arranged side by side on opposite sides of the second display area along the first direction.

14. The display panel according to claim 13, wherein one of the two adjacent second scan lines is electrically connected to the third gate sub-drive circuit, and another second scan line is electrically connected to the fourth gate sub-drive circuit.

15. The display panel according to claim 3, wherein the pixels located in the first display area include a plurality of first pixel electrodes, and the first source drive circuit is electrically connected to the first pixel electrodes through the first data lines; and
the pixels located in the second display area include a plurality of second pixel electrodes, and the second source drive circuit is electrically connected to the second pixel electrodes through the second data lines.

16. The display panel according to claim 1, wherein the first display area includes a first common electrode, the second display area includes a second common electrode, and the first common electrode is electrically insulated from the second common electrode.

17. The display panel according to claim 1, wherein the display panel further comprises a linkage control unit electrically connected to the first source drive and the second source drive circuit.

18. A display panel, comprising:
a display area including a first display area and a second display area adjacent to the first display area;
wherein pixels located in the first display area are driven to display by a first source drive circuit and pixels located in the second display area are driven to display by a second source drive circuit;
wherein first scan lines are arranged in the first display area and electrically connected to the pixels located in the first display area, second scan lines are arranged in the second display area and electrically connected to the pixels located in the second display area, the first scan lines and the second scan lines extend along a first direction, and the first display area and the second display area are arranged side by side along the first direction;
wherein the first source drive circuit is electrically insulated from the second source drive circuit, and the first scan lines are electrically insulated from the second scan lines.

19. A display device, comprising a display panel, wherein the display panel comprises:
a display area including at least a first display area and a second display area adjacent to the first display area;
wherein pixels located in the first display area are driven to display by at least one first source drive circuit and pixels located in the second display area are driven to display by at least one second source drive circuit;
wherein the first source drive circuit is electrically insulated from the second source drive circuit.

20. The display device according to claim 19, wherein first scan lines are arranged in the first display area and electrically connected to the pixels located in the first display area, second scan lines are arranged in the second display area and electrically connected to the pixels located in the second display area, the first scan lines and the second scan lines extend along a first direction, and the first display area and the second display area are arranged side by side along the first direction;
the first scan lines are electrically insulated from the second scan lines.
